(19) United States
(12) Patent Application Publication
(10) Pub. No.: US 2010/0080989 A1
(43) Pub. Date: Apr. 1, 2010

(54) PRESSURE-SENSITIVE ADHESIVE SHEET FOR LASER PROCESSING AND METHOD FOR LASER PROCESSING

(75) Inventors: Fumiteru ASAI, Ibaraki-shi (JP); Tomokazu TAKAHASHI, Ibaraki-shi (JP); Keiko MAEKAWA, Ibaraki-shi (JP); Kazuhiro AOYAGI, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/571,618

(22) Filed: Oct. 1, 2009

(30) Foreign Application Priority Data
Oct. 1, 2008 (JP) 2008-255896

(51) Int. Cl. B32B 15/082; B29C 65/16

(52) U.S. Cl. 428/345; 156/272.8

(57) ABSTRACT

The present invention provides a pressure-sensitive adhesive sheet for laser processing, which includes a base and a pressure-sensitive adhesive layer provided on one surface of the base, the pressure-sensitive adhesive layer having an absorption coefficient at a wavelength of 355 nm of from 50 cm⁻¹ to 900 cm⁻¹, the pressure-sensitive adhesive layer containing a light-absorbing agent in which an absorbance of the light-absorbing agent in a 0.01% by weight acetonitrile solution at a wavelength of 355 nm is from 0.01 to 1.20, and in which the pressure-sensitive adhesive sheet is to be used at the time when a workpiece is laser-processed by a laser light having a wavelength of an ultraviolet region or a laser light enabling light absorption via multiphoton absorption process.

### FIELD OF THE INVENTION

The present invention relates to a pressure-sensitive adhesive sheet for laser processing, which is to be used at the time when a workpiece is laser-processed by a laser light having a wavelength of an ultraviolet region or a laser light enabling light absorption via multiphoton absorption process; and a method for laser processing.

### BACKGROUND OF THE INVENTION

With recent miniaturization and the like of electrical and electronic devices, their parts have been decreasing in size and increasing in fineness. Accordingly, there is a need for greater fineness and precision also in the cutting of various materials. In particular, in the semiconductor field where there is a great need for smaller size and higher density, attention in recent years has been directed to methods for cutting semiconductor wafers with a laser light, which causes little heat damage and allows high-precision processing.

As the above technique, there has been proposed a method including fixing to a dicing sheet a workpiece obtained by subjecting a substrate to various circuit formation and surface treating steps, and dicing the workpiece with a laser light to form small chips. As the dicing sheet to be used in such a method, there has been proposed a dicing sheet comprising a base including a base film and a pressure-sensitive adhesive layer formed on a surface of the base, in which the pressure-sensitive adhesive layer is cut by the laser light without cutting the base film (e.g., see JP-A-2002-343747).

In the case where a laser light is employed for dicing the workpiece, a stress is imparted to the workpiece by ablation with the laser light and hence there occurs a so-called chip fry that separated pieces of the workpiece cannot be held on a pressure-sensitive adhesive sheet for laser processing to lose some pieces of the workpiece. Accordingly, there is a problem that the separated pieces of the workpiece cannot be efficiently collected.

In the case where the dicing sheet described in JP-A-2002-343747 is used, the pressure-sensitive adhesive layer is thermally cut by a fundamental wave (wavelength: 1064 nm) of YAG laser or a laser light of ruby laser (wavelength: 694 nm). Therefore, with the laser cutting, decomposition by thermal processing occurs not only at the upper layer of the pressure-sensitive adhesive layer but also at the inside of the pressure-sensitive adhesive layer or the interface between the base and the pressure-sensitive adhesive layer, so that processing of the pressure-sensitive adhesive layer in a transverse direction is apt to occur. Accordingly, the dicing sheet is insufficient for suppressing the chip fry of separated pieces of the workpiece.

### SUMMARY OF THE INVENTION

An object of the present invention is to provide a pressure-sensitive adhesive sheet for laser processing and a method for laser processing, wherein separated pieces of a workpiece can be held on the pressure-sensitive adhesive sheet for laser processing, chip fry can be suppressed, and also the separated pieces of the workpiece can be efficiently collected.

As a result of extensive studies for solving the above problems, the present inventors have found that the above object can be achieved by the following pressure-sensitive adhesive sheet for laser processing and thus have accomplished the invention.

Namely, the present invention provides:

a pressure-sensitive adhesive sheet for laser processing, which includes a base and a pressure-sensitive adhesive layer provided on one surface of the base,

the pressure-sensitive adhesive layer having an absorption coefficient at a wavelength of 355 nm of from 50 cm⁻¹ to 900 cm⁻¹,

the pressure-sensitive adhesive layer containing a light-absorbing agent in which an absorbance of the light-absorbing agent in a 0.01% by weight acetonitrile solution at a wavelength of 355 nm is from 0.01 to 1.20, and

in which the pressure-sensitive adhesive sheet is to be used at the time when a workpiece is laser-processed by a laser light having a wavelength of an ultraviolet region or a laser light enabling light absorption via multiphoton absorption process.

The above-mentioned pressure-sensitive adhesive sheet for laser processing is laminated on an adsorption stage surface (laser light-exiting surface) of the workpiece prior to laser processing of the workpiece by ultraviolet absorption ablation with a laser light to be used for supporting and fixing the workpiece (article to be processed with laser or laser-processed article) at processing and during subsequent each step.

The absorption coefficient of the pressure-sensitive adhesive layer at a wavelength of 355 nm is preferably from 50 cm⁻¹ to 900 cm⁻¹, more preferably from 70 cm⁻¹ to 800 cm⁻¹, further preferably from 90 cm⁻¹ to 600 cm⁻¹, and even further preferably from 100 cm⁻¹ to 400 cm⁻¹. When the absorption coefficient of the pressure-sensitive adhesive layer at a wavelength of 355 nm falls within the range, even after a laser light cuts the workpiece and reaches the pressure-sensitive adhesive layer, the pressure-sensitive adhesive layer moderately absorbs the laser light and ablation processing proceeds from the upper layer part to the lower layer part of the pressure-sensitive adhesive layer in sequence. On this occasion, since a processed pressure-sensitive adhesive component is released to outside of the system along a processing line, a stress by ablation is not imparted to the workpiece and prevention of chip fry can be surely achieved. In this connection, in the case where the absorption coefficient of the pressure-sensitive adhesive layer at a wavelength of 355 nm is less than 50 cm⁻¹, the laser light transmits the pressure-sensitive adhesive layer and ablation of a base occurs at the interface between the pressure-sensitive adhesive layer and the base to burst the pressure-sensitive adhesive layer. Therefore, the pressure-sensitive adhesive layer is also processed in a transverse direction and a stress in a transverse direction is imparted also to the workpiece, so that the chip fry is apt to occur. Moreover, when the absorption coefficient of the pressure-sensitive adhesive layer at a wavelength of 355 nm is more than 900 cm⁻¹, laser light absorbability of the pressure-sensitive adhesive layer is high and conversion efficiency into heat energy on the surface of the pressure-sensitive adhesive layer at the workpiece side increases, so that ablation of the pressure-sensitive adhesive layer becomes too large. Accordingly, the pressure-sensitive adhesive layer also receives a stress in a transverse direction and a stress in a transverse direction is also imparted to the workpiece, so that the chip fry is apt to occur.

The absorbance of the light-absorbing agent, which is contained in the pressure-sensitive adhesive layer, in a 0.01% by weight acetonitrile solution at a wavelength of 355 nm is preferably from 0.01 to 1.20, more preferably from 0.02 to 1.00, and further preferably from 0.03 to 0.95, in order to prevent too high content or too low content of the agent.

Moreover, the light-absorbing agent is preferably a photoreactive polymerization initiator.

The photoreactive polymerization initiator is preferably any of an alkylphenone-based compound, an α-alkylphenone-based compound, and an acylphosphine oxide-based compound. By changing the amount of these photoreactive polymerization initiators different in absorbance at a wavelength of 355 nm, the laser absorbability of the pressure-sensitive adhesive layer can be easily controlled. These light-absorbing agents may be added singly or two or more thereof may be added. The pressure-sensitive adhesive layer preferably contains an acrylic polymer.

By using the acrylic polymer, contamination with the pressure-sensitive adhesive layer and the like can be easily controlled.

The pressure-sensitive adhesive layer preferably contains an ultraviolet ray-curable pressure-sensitive adhesive. By using the ultraviolet ray-curable pressure-sensitive adhesive, the holding ability at processing and the peeling from the workpiece by peeling the layer after irradiation with an ultraviolet ray can be easily achieved.

The pressure-sensitive adhesive layer preferably contains a pressure-sensitive adhesive containing an acrylic polymer having a carbon-carbon double bond in a side chain thereof.

The absorption coefficient of the base at a wavelength of 355 nm is preferably 10 cm⁻¹ or less.

The base is preferably a base having a layer composed of polyethylene or polypropylene.

The base is preferably a base having at least one layer composed of a copolymer containing ethylene. Owing to this constitution, the base hardly absorbs the laser light and thus ablation by the laser light hardly occurs. Therefore, a force imparted to the workpiece, which is caused by the ablation of the base, can be minimized and the chip fry can be prevented.

The workpiece is preferably a semiconductor element.

The present invention also provides:

a method for laser processing, which includes:

attaching the above-mentioned pressure-sensitive adhesive sheet to a workpiece, and

subsequently irradiating the workpiece with a laser light having a wavelength of a ultraviolet region or a laser light enabling light absorption via multiphoton absorption process from a surface opposite to the surface to which the pressure-sensitive adhesive sheet has been attached, thereby processing the workpiece by ablation.

In this method, the workpiece may be a semiconductor element, and the semiconductor element may be separated into pieces by irradiation with the laser light to form semiconductor chips.

### BRIEF DESCRIPTION OF THE DRAWINGS

FIG. 1 is a schematic view showing cross-section of a laminate processed by ultraviolet absorption ablation with a laser light.

FIG. 2 is a schematic view showing an example of a dicing method of a semiconductor wafer in the invention.

### DESCRIPTION OF REFERENCE NUMERALS AND SIGNS

1 workpiece
2 pressure-sensitive adhesive sheet for laser processing
2a pressure-sensitive adhesive layer
2b base
3 laminate
4 adsorption stage
5 adsorption plate
6 laser light
7 semiconductor wafer
8 dicing flame

### DETAILED DESCRIPTION OF THE INVENTION

As the laser to be used in the invention, in order not to deteriorate accuracy and appearance of edge of holes and cut wall surfaces of the workpiece by thermal damage at laser processing, a laser capable of ablation processing through ultraviolet ray absorption, which is non-thermal processing without passing through heat processing process, is employed.

Specifically, there may be mentioned a laser with an oscillation wavelength of 400 nm or less, e.g., KrF excimer laser with an oscillation wavelength of 248 nm, XeCI excimer laser with an oscillation wavelength of 308 nm, and a third harmonic (355 nm) or a fourth harmonic (266 nm) of a YAG laser or, in case of a laser with an oscillation wavelength of 400 nm or more, a titanium sapphire laser with a wavelength from 750 nm to 800 nm, with pulse width of 1 e⁻⁹ second (0.000000001 second) or less capable of light absorption in an ultraviolet region via multiphoton absorption process and capable of cutting with a width of 20 μm or less by multiphoton absorption ablation. In particular, it is preferred to use a laser which allows focusing a laser light within a fine width of 20 μm or less and radiates an ultraviolet ray of 355 nm.

The workpiece is not particularly limited so long as it can be processed by ultraviolet absorption ablation with the laser light output by the above-mentioned laser. Examples thereof include various sheet materials, circuit boards, semiconductor wafers, glass substrates, ceramic substrates, metal substrates, substrates for light-emitter or photoreceptor of semiconductor lasers or the like, substrates for MEMS (Micro Electro Mechanical System), semiconductor packages, fabrics, leathers, papers, and the like.

The pressure-sensitive adhesive sheet for laser processing of the invention can be suitably used particularly for processing sheet materials, circuit boards, semiconductor wafers, glass substrates, ceramic substrates, metal substrates, substrates for light-emitter or photoreceptor of semiconductor lasers, substrates for MEMS, or semiconductor packages.

Examples of the above-mentioned various sheet materials include polymer films and non-woven fabrics composed of a polyimide resin, a polyester resin, an epoxy resin, a urethane resin, a polystyrene resin, a polyethylene resin, a polyamide resin, a polycarbonate resin, a silicon resin, a fluorocarbon polymer, or the like; sheets to which a physical or optical function is imparted by drawing, impregnation, or the like of the resins; metallic sheets of cupper, aluminum, stainless steel, or the like; and laminates of the above-mentioned polymer films and/or metallic sheets directly or via an adhesive or the like.

Examples of the above-mentioned circuit boards include one-sided, double-sided, or multi-layered flexible printed boards; rigid boards composed of glass epoxy, ceramic, or metal core substrates; and optical circuit or optical-electric hybrid circuit boards formed on glass or polymers.

Examples of the forming material of the base include polyethylene terrephthalate, polyethylene naphthalate, polystyrene, polycarbonate, polyimides, (meth)acrylic polymers, polyurethane-based resins, polynorbornene-based resins, polyalkylene glycol-based resins such as polyethylene glycol and polytetramethylene glycol, silicone-based rubbers, and polyolefine-based resins such as polyethylene, polypropylene, polybutadiene, polyvinyl alcohol, and polymethylpentene, but the forming material is not limited thereto.

Of these, it is preferred to use a polyolefin-based resin. Particularly, it is preferred to use an ethylene-vinyl acetate copolymer or a linear saturated hydrocarbon-based resin such as polyethylene or polypropylene. Since the etching rate of polyethylene having no functional group in the side chain thereof is extremely small and laser processability is particularly low, the generation of polyethylene decomposition products can be effectively suppressed.

The base may be monolayer or multilayer. Moreover, it may be in various forms such as film or mesh. Particularly, a base having a large void ratio, such as fibrous one, nonwoven fabric, woven fabric, or porous one of the above resin is suitable.

The thickness of the base can be optionally regulated within the range where operability and workability are not impaired in individual steps of attachment to the workpiece, cutting and boring of the workpiece, and peeling and collection of laser-processed articles but is usually 500 μm or less, preferably from about 5 μm to about 300 μm, and more preferably from 10 μm to 250 μm. In order to enhance adhesiveness and holding ability with adjacent material such as an adsorption plate, the surface of the base may be subjected to conventional surface treatment, e.g., chemical or physical treatment such as treatment with chromic acid, exposure to ozone, exposure to flame, exposure to high-voltage electric shock, or ionized radiation treatment or coating treatment with an undercoat (e.g., pressure-sensitive adhesive substances to be mentioned below).

The absorption coefficient of the base at a wavelength of 355 nm is preferably 10 cm⁻¹ or less. Moreover, the base is preferably a base having at least one layer composed of polyethylene or polypropylene. Furthermore, the base is a base having at least one layer composed of a copolymer containing ethylene.

As the forming material of the pressure-sensitive adhesive layer, a known pressure-sensitive adhesive including a (meth)acrylic polymer or a rubber-based polymer can be used.

Examples of the monomer component forming the (meth)acrylic polymer include alkyl (meth)acrylates having a linear or branched alkyl group of 30 carbon atoms or less, preferably 3 to 18 carbon atoms, such as a methyl group, an ethyl group, an n-propyl group, an isopropyl group, an n-butyl group, a t-butyl group, an isobutyl group, an amyl group, an isoamyl group, a hexyl group, a heptyl group, a cyclohexyl group, a 2-ethylhexyl group, an octyl group, an isooctyl group, a nonyl group, an isononyl group, a decyl group, an isodecyl group, an undecyl group, a lauryl group, a tridecyl group, a tetradecyl group, a stearyl group, an octadecyl group, or a dodecyl group. These alkyl (meth)acrylates may be used singly or two or more thereof may be used in combination.

Examples of the monomer component other than the above-mentioned monomer component include carboxyl group-containing monomers such as acrylic acid, methacrylic acid, carboxyethyl (meth)acrylate, carboxypentyl (meth)acrylate, itaconic acid, maleic acid, fumaric acid, and crotonic acid; acid anhydride monomers such as maleic anhydride and itaconic anhydride; hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methyl (meth)acrylate; sulfonic acid group-containing monomers such as styrenesulfonic acid, allylsulfonic acid, 2-(meth)acrylamide-2-methylpropanesulfonic acid, (meth)acylamidopropanesulfonic acid, sulfopropyl (meth)acrylate, and (meth)acryloyloxynaphthalenesulfonic acid; and phosphoric acid group-containing monomers such as 2-hydroxyethyl acryloyl phosphate. These monomer components may be used singly or two or more thereof may be used in combination.

Moreover, for the purpose of crosslinking treatment of the (meth)acrylic polymer, a multifunctional monomer or the like can be also used as a copolymerization monomer component according to needs.

Examples of the multifunctional monomer include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, epoxy (meth)acrylate, polyester (meth)acrylate, and urethane (meth)acrylate. These multifunctional monomers may be used singly or two or more thereof may be used in combination.

The amount of the multifunctional monomer to be used is preferably 30% by weight or less, more preferably 20% by weight or less of the total monomer components from the viewpoint of pressure-sensitive adhesiveness and the like.

The preparation of the (meth)acrylic polymer can, for example, be performed by applying a suitable method such as a solution polymerization method, an emulsion polymerization method, a bulk polymerization method, or a suspension polymerization method on a mixture containing one or two or more monomer components.

Examples of a polymerization initiator include peroxides such as hydrogen peroxide, benzoyl peroxide, and t-butyl peroxide. The polymerization initiator is preferably used singly but may be also used as a redox polymerization initiator in combination with a reducing agent. Examples of the reducing agent include ionized salts such as sulfite salts, hydrogen sulfite salts, iron, copper, and cobalt salts, amines such as triethanolamine, and reducing sugars such as aldose and ketose. In addition, an azo compound is also a preferable polymerization initiator and 2,2′-azobis-2-methylpropioamidine acid salt, 2,2′-azobis-2,4-dimethylvalerontrile, 2,2′-azobis-N,N′-dimethyleneisobutyramidine acid salt, 2,2′-azobisisobutyronitrile, 2,2′-azobis-2-methyl-N-(2-hydroxyethyl)propionamide, and the like can be used. It is also possible to use two or more kinds of the polymerization initiators in combination.

The reaction temperature is usually from about 50° C. to about 85° C. and the reaction time is from about 1 hour to about 24 hours. Moreover, the solution polymerization is preferred among the above-mentioned production methods and, in general, a polar solvent such as ethyl acetate or toluene is used as a solvent for the (meth)acrylic polymer. The solution concentration is usually from about 20% by weight to about 80% by weight.

In order to enhance number-average molecular weight of the (meth)acrylic polymer as a base polymer, a crosslinking agent may be suitably added to the pressure-sensitive adhesive. Examples of the crosslinking agent include polyisocyanate compounds, epoxy compounds, aziridine compounds, melamine resins, urea resins, anhydride compounds, polyamines, and carboxyl group-containing polymers. In the case where the crosslinking agent is used, generally, the amount is preferably from about 0.01 part by weight to about 10 parts by weight based on 100 parts by weight of the base polymer with considering that the pressure-sensitive adhesive force at peeling does not decrease too much. Moreover, in the pressure-sensitive adhesive which forms the pressure-sensitive adhesive layer, in addition to the above-mentioned components, conventional additives such as various tackifiers, antiaging agents, fillers, and colorants which are hitherto known can be incorporated.

In order to further improve peeling properties from the workpiece, the pressure-sensitive adhesive may be a radiation-curable pressure-sensitive adhesive which is cured with radiation ray such as an ultraviolet ray or an electron beam. In this connection, in the case where the radiation-curable pressure-sensitive adhesive is used as the pressure-sensitive adhesive, the pressure-sensitive adhesive layer is irradiated with a radiation ray after laser processing, so that the base is preferably one having a sufficient radiation ray transmittance.

As the radiation curable pressure-sensitive adhesive, one having a radiation curable functional group such as a carbon-carbon double bond and showing a pressure-sensitive adhesiveness can be used without particular limitation. Examples of the radiation curable pressure-sensitive adhesive include radiation curable pressure-sensitive adhesives in which a radiation curable monomer component or oligomer component is mixed into the aforementioned (meth)acrylic polymer.

Examples of the radiation curable monomer component or oligomer component to be mixed include urethane (meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, and 1,4-butylene glycol di(meth)acrylate. They may be used singly or two or more thereof may be used in combination.

The amount of the radiation curable monomer component or oligomer component to be mixed is not particularly limited but, in consideration of adhesiveness, the amount is preferably from about 5 parts by weight to about 500 parts by weight, more preferably from about 70 parts by weight to about 150 parts by weight based on 100 parts by weight of the base polymer constituting the pressure-sensitive adhesive, such as the (meth)acrylic polymer.

Moreover, as the radiation curable pressure-sensitive adhesive, substance having a carbon-carbon double bond in the polymer side chain or main chain or at the main chain end can be also used as the base polymer. As such a base polymer, one having the (meth)acrylic polymer as a fundamental skeleton is preferred. In this case, the radiation curable monomer component or oligomer component may be not particularly added and its use is optional.

In the radiation curable pressure-sensitive adhesive, a photoreactive polymerization initiator is contained in the case where the adhesive is cured with an ultraviolet ray. Examples of the photoreactive polymerization initiator include alkylphenone-based compounds such as 2,2-dimethoxy-1,2-diphenylethan-1-one, 1-hydroxy-cyclohexyl-phenyl-ketone, 2-hydroxy-2-methyl-1-phenyl-propan-1-one, 144-(2-hydroxyethoxy)-phenyl-2-hydroxy-2-methyl-1-propan-1-one, and 2-hydroxy-1-{4-[4-(2-hydroxy-2-methyl-propionyl)-benzyl]phenyl}-2-methyl-propan-1-one; α-alkylphenone-based compounds such as 2-methyl-1-(4-methylthiophenyl)-2-morpholinopropan-1-one, 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone; acylphosphine oxide-based compounds such as 2,4,6-trimethylbenzoyl-diphenyl-phosphine oxide, and bis(2,4,6-trimethylbenzoyl)-phenylphosphine oxide.

The amount of the photoreactive polymerization initiator to be mixed is suitably selected from the range where the absorption coefficient of the pressure-sensitive adhesive layer at a wavelength of 355 nm becomes from 50 cm⁻¹ to 900 cm⁻¹ since the absorbance at a wavelength of 355 nm varies for every photoreactive polymerization initiator. The amount is preferably from 0.5 part by weight to 20 parts by weight based on 100 parts by weight of the base polymer. In the radiation curable pressure-sensitive adhesive, when the amount of the photoreactive polymerization initiator is less than 0.5 part by weight, curing of the pressure-sensitive adhesive by irradiation with a radiation ray becomes insufficient or uneven and thus decrease in pressure-sensitive adhesive force is limited. Moreover, when the amount exceeds 20 parts by weight, there arise problems of decrease in stability of the pressure-sensitive adhesive, increased contamination to articles to be cut, and the like. Using from 0.5 part by weight to 20 parts by weight of the photoreactive polymerization initiator based on 100 parts by weight of the base polymer, in order to adjust the absorption coefficient of the pressure-sensitive adhesive layer at a wavelength of 355 nm to from 50 cm⁻¹ to 900 cm⁻¹, the absorbance of the photoreactive polymerization initiator at a wavelength of 355 nm in a 0.01% by weight acetonitrile solution is preferably from 0.01 to 1.20.

The pressure-sensitive adhesive sheet for laser processing according to the invention can be produced by applying a pressure-sensitive adhesive solution on the surface of the base and drying it (if necessary, heating to effect crosslinking) to form a pressure-sensitive adhesive layer. Moreover, there may be employed a method of separately forming a pressure-sensitive adhesive layer on a peeling liner and subsequently attaching the layer to the base. If necessary, a separator may be provided on the surface of the pressure-sensitive adhesive layer.

The pressure-sensitive adhesive layer preferably has a low content of low-molecular-weight substances from the viewpoint of prevention of contamination to the workpiece. Therefore, the weight-average molecular weight of the (meth)acrylic polymer is preferably 300,000 or more, more preferably from 400,000 to 3,000,000.

The thickness of the pressure-sensitive adhesive layer is suitably selected from the range where the layer is not peeled off the workpiece but is usually from about 2 μm to about 300 μm, preferably from about 5 μm to about 100 μm, and more preferably from about 10 μm to about 50 μm.

The pressure-sensitive adhesive force of the pressure-sensitive adhesive sheet for laser processing after ultraviolet irradiation is preferably from 0.05 N/20 mm to 2.0 N/20 mm, more preferably from 0.20 N/20 mm to 1.50 N/20 mm, and particularly preferably from about 0.40 N/20 mm to about 1.00 N/20 mm.

A separator is optionally provided for label processing or protection of the pressure-sensitive adhesive layer.

Examples of the constituting material of the separator include papers and films of synthetic resins such as polyethylene, polypropylene, and polyethylene terephthalate. In order to enhance the peeling ability from the pressure-sensitive adhesive layer, the surface of the separator may be subjected to peeling treatment such as silicone treatment, long-chain alkyl treatment, or fluorine treatment according to needs. Moreover, if necessary, the separator may be subjected to treatment for preventing ultraviolet transmission or the like so as to prevent the pressure-sensitive adhesive sheet from reacting with environmental ultraviolet rays. The thickness of the separator is usually from 10 μm to 200 μm, preferably from about 25 μm to about 100 μm.

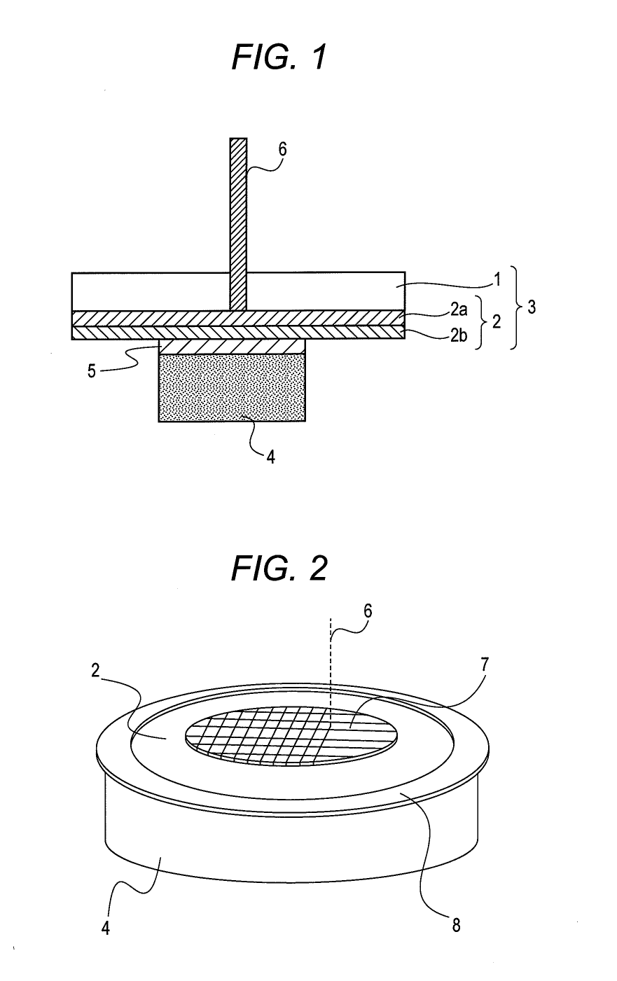

The following will describe the process for producing a laser-processed article by ultraviolet ablation with a laser light using the above-mentioned pressure-sensitive adhesive sheet for laser processing. For example, in the case of cutting, as shown in FIG. 1, a laminate 3 of a workpiece 1 and a pressure-sensitive adhesive sheet for laser processing 2 obtained by attaching the pressure-sensitive adhesive sheet 2 to the workpiece 1 by a known means such as a roll laminator or a press is placed on an adsorption plate 5 of an adsorption stage 4, a laser light 6 outputted from a predetermined laser oscillator is focused and applied on the workpiece 1 through a lens, and the laser irradiation position is transferred along a predetermined processing line to thereby perform cutting. The pressure-sensitive adhesive sheet for laser processing 2 to be provided on the laser light-emerging side of the workpiece 1 plays a role of supporting and fixing the workpiece 1 before laser processing and plays a role of preventing dropping of cut articles after laser processing. In this connection, a protective sheet may be provided on the laser light-entering side of the workpiece 1. The protective sheet is used for preventing attachment of decomposed matter and flying matter generated by laser processing of the workpiece 1 onto the surface of the workpiece 1.

As a transferring means of the laser light, a known laser processing method such as galvano scan or X-Y stage scan, or mask imaging processing is employed.

The conditions for laser processing are not particularly limited as far as the workpiece 1 is completely cut under the conditions. However, in order to avoid cutting the pressure-sensitive adhesive sheet for laser processing 2, it is preferred to adjust the energy condition within twice the energy condition under which the workpiece 1 is cut.

Moreover, a tab for cutting (cutting groove) can be made fine by focusing the beam diameter of the focusing part of the laser light. In order to achieve accuracy of cut edge, it is preferred to satisfy the following relationship:

beam diameter(μm)>2×(rate of transferring laser light(μm/sec)/repeating frequency of laser light(Hz)).

In the case of cutting (dicing) of semiconductor wafers, as shown in FIG. 2, one surface of the semiconductor wafer 7 is attached to the pressure-sensitive adhesive sheet for laser processing 2 provided on the adsorption stage 4, a laser light 6 outputted from a predetermined laser oscillator is focused and applied on the semiconductor wafer 7 through a lens, and the laser irradiation position is transferred along a predetermined processing line to thereby perform cutting. As a transferring means of the laser light, a known laser processing method such as galvano scan or X-Y stage scan, or mask imaging processing is employed. The conditions for laser processing of a semiconductor wafer are not particularly limited as far as the semiconductor wafer 7 is completely cut and the pressure-sensitive adhesive sheet for laser processing 2 is not cut under the conditions. In this connection, a protective sheet may be provided on the laser light-entering side of the semiconductor wafer 7.

In such a dicing processing of the semiconductor wafers, individual semiconductor chips can be picked up and collected by a known method such as a method including cutting the wafer into individual semiconductor chips (laser-processed articles) and subsequently picking up them using a push-up pin called a needle by means of a conventionally known apparatus such as a die bonder, or a method shown in JP-A-2001-118862.

In the process for producing the laser-processed articles according to the invention, the laser-processed articles on the pressure-sensitive adhesive sheet are collected after completion of laser processing. The method for peeling them is not particularly limited and it is important not to impart a stress which permanently deform the laser-processed articles at peeling. Since the pressure-sensitive adhesive sheet of the invention has a small pressure-sensitive adhesive force, the laser-processed articles is not permanently deformed and can be easily peeled off. Moreover, in the case where a radiation curable pressure-sensitive adhesive is used for the pressure-sensitive adhesive layer of the pressure-sensitive adhesive sheet for laser processing 2, the pressure-sensitive adhesive layer is cured by irradiation with a radiation ray depending on the kind of the pressure-sensitive adhesive to decrease pressure-sensitive adhesiveness. Owing to irradiation with the radiation ray, the pressure-sensitive adhesiveness of the pressure-sensitive adhesive layer can be decreased by curing to facilitate the peeling. The means for the irradiation with radiation is not particularly limited but the irradiation is performed, for example, by irradiation with an ultraviolet ray.

Moreover, the removal of the decomposed matter through scattering can be efficiently achieved by blowing the laser-processed part with a gas such as helium, nitrogen, or oxygen. A protective sheet may be provided on the laser light-entering side of the workpiece 1.

Moreover, the pressure-sensitive adhesive sheet for laser processing according to the invention is also used for the production of laser-processed articles having various shapes, for example, boring by ultraviolet absorption ablation with a laser light.

### EXAMPLES

The following will specifically describe the invention with reference to Examples but the invention is not limited to these Examples.

Measurement of Absorption Coefficient The absorption coefficients of a sheet-shaped pressure-sensitive adhesive and a base at a wavelength of 355 nm were measured by the following method. Using an ultraviolet visible spectrophotometer UV-2550 (manufactured by Shimadzu Corporation), the sheet-shaped pressure-sensitive adhesive or the base was fixed to a jig and transmittance T (%) and reflectance R (%) at a wavelength of 355 nm were measured, followed by calculation according to the following equation.

T′=T/(100−R)

Absorption coefficient(cm⁻¹)=LN(1/T′)/thickness of sheet-shaped pressure-sensitive adhesive or base(cm)

Measurement of Absorbance of Light-Absorbing Agent

The absorbance of light-absorbing agent at a wavelength of 355 nm was measured by the following method. As an analyte to be measured, a solution diluted to 0.01% by weight with acetonitrile for spectroscopy (manufactured by Kishida Chemical Co., Ltd.) was used. A quartz glass cell (light path: 1 cm) containing the diluted solution was placed on the ultraviolet visible spectrophotometer UV-2550 (manufactured by Shimadzu Corporation) and the transmittance T (%) at a wavelength of 355 nm was measured, followed by calculation according to the following equation.

Absorbance=LOG(100/T)

### Example 1

An acrylic pressure-sensitive adhesive (1) was applied onto a base composed of an ethylene-vinyl acetate copolymer (thickness: 100 μm, absorption coefficient: 6.8 cm⁻¹, vinyl acetate content: 10%, melt mass flow rate: 9 g/10 min) and dried to form a pressure-sensitive adhesive layer, thereby obtaining a pressure-sensitive adhesive sheet for laser processing. The thickness of the pressure-sensitive adhesive layer was 20 μm and the absorption coefficient at a wavelength of 355 nm was 102. 6 cm⁻¹.

In this regard, the acrylic pressure-sensitive adhesive (1) was prepared by the following method. Fifty parts by weight of 2-ethylhexyl acrylate (2-EHA), 50 parts by weight of methyl acrylate (MA), and 10 parts by weight of acrylic acid (AA) were polymerized in ethyl acetate using 0.2 part by weight of a polymerization initiator, benzoyl peroxide (BPO) to obtain an acrylic polymer solution. One hundred parts by weight of the acrylic polymer, 3.5 parts by weight of an isocyanate crosslinking agent (Coronate L, manufactured by Nippon Polyurethane Industry Co., Ltd.), 50 parts by weight of a UV curable urethane acrylate oligomer (UV-1700B), and 5 parts by weight of a photoreactive polymerization initiator, 2,2-dimethoxy-1,2-diphenylethan-1-one (absorbance at a wavelength of 355 nm in a 0.01% by weight acetonitrile solution: 0.06) were added to toluene and were homogeneously dissolved with mixing.

The above-prepared pressure-sensitive adhesive sheet for laser processing was attached to one side of a silicon wafer having a thickness of 100 μm to prepare a silicon wafer fitted with a pressure-sensitive adhesive sheet. Then, on an XY stage on which an adsorption plate made of a glass epoxy resin was placed, the wafer was disposed so that the workpiece was on top. The silicon wafer was cut by focusing a third harmonic (355 nm) of a YAG laser having a wavelength of 355 nm, an average output of 2.5 W, and a repeating frequency of 1 kHz through an fθ lens to the surface of the silicon wafer with a diameter of 25 mm, scanning the laser light at a rate of 2.5 mm/second by means of galvano scanner, and repeating the laser irradiation three times, thereby dicing into a chip size of 0.3 mm×0.3 mm being achieved. The chip fry ratio on this occasion (disappearance ratio of chips after laser dicing) was 0%.

### Example 2

A silicon wafer fitted with a pressure-sensitive adhesive sheet was subjected to laser processing in the same manner as in Example 1 except that the amount of the photoreactive polymerization initiator to be added to the pressure-sensitive adhesive was changed to 9 parts by weight in Example 1. The thickness of the pressure-sensitive adhesive layer was 20 μm and the absorption coefficient at a wavelength of 355 nm was 197.9 cm⁻¹. The chip fry ratio was 0%.

### Example 3

A silicon wafer fitted with a pressure-sensitive adhesive sheet was subjected to laser processing in the same manner as in Example 1 except that 0.5 part by weight of 2-benzyl-2-dimethylamino-1-(4-morpholinophenyl)-butanone-1 (absorbance at a wavelength of 355 nm in a 0.01% by weight acetonitrile solution: 0.81) was used as a photoreactive polymerization initiator to be added to the pressure-sensitive adhesive in Example 1. The thickness of the pressure-sensitive adhesive layer was 20 μm and the absorption coefficient at a wavelength of 355 nm was 245.9 cm⁻¹. The chip fry ratio was 0%.

### Example 4

A silicon wafer fitted with a pressure-sensitive adhesive sheet was subjected to laser processing in the same manner as in Example 1 except that an acrylic pressure-sensitive adhesive (2) was used in Example 1. The thickness of the pressure-sensitive adhesive layer was 20 μm and the absorption coefficient at a wavelength of 355 nm was 833.1 cm⁻¹. The chip fry ratio was 0%.

The acrylic pressure-sensitive adhesive (2) was prepared by the following method. Seventy parts by weight of 2-methoxyethyl acrylate (2MEA), 30 parts by weight of acryloylmorpholine (ACMO), and 15 parts by weight of 2-hydroxyethyl acrylate (2HEA) were polymerized in ethyl acetate using 0.2 part by weight of a polymerization initiator, benzoyl peroxide (BPO) to obtain an acrylic polymer solution. Sixteen parts by weight of 2-methacryloyloxyethyl isocyanate (MOI) was reacted therewith to obtain a solution of an acrylic polymer having a carbon-carbon double bond in a side chain thereof. One hundred parts by weight of the acrylic polymer, 1 part by weight of an isocyanate crosslinking agent (Coronate L, manufactured by Nippon Polyurethane Industry Co., Ltd.), and 2 parts by weight of a photoreactive polymerization initiator, 2-benzyl-2-dimethylamino-1-(4-morpholinophenyl)-butanone-1 were added to toluene and were homogeneously dissolved with mixing.

### Example 5

A silicon wafer fitted with a pressure-sensitive adhesive sheet was subjected to laser processing in the same manner as in Example 1 except that an acrylic pressure-sensitive adhesive (3) was used in Example 1. The thickness of the pressure-sensitive adhesive layer was 20 μm and the absorption coefficient at a wavelength of 355 nm was 499 cm⁻¹. The chip fry ratio was 0%.

The acrylic pressure-sensitive adhesive (3) was prepared by the following method. Seventy parts by weight of 2-ethylhexyl acrylate (2EHA), 30 parts by weight of acryloylmorpholine (ACMO), and 15 parts by weight of 2-hydroxyethyl acrylate (2HEA) were polymerized in ethyl acetate using 0.2 part by weight of a polymerization initiator, benzoyl peroxide (BPO) to obtain an acrylic polymer solution. Ten parts by weight of 2-methacryloyloxyethyl isocyanate (MOI) was reacted therewith to obtain a solution of an acrylic polymer having a carbon-carbon double bond in a side chain thereof. One hundred parts by weight of the acrylic polymer, 1 part by weight of an isocyanate crosslinking agent (Coronate L, manufactured by Nippon Polyurethane Industry Co., Ltd.), and 2 parts by weight of a photoreactive polymerization initiator, 2-benzyl-2-dimethylamino-1-(4-morpholinophenyl)-butanone-1 were added to toluene and were homogeneously dissolved with mixing.

### Comparative Example 1

A silicon wafer fitted with a pressure-sensitive adhesive sheet was subjected to laser processing in the same manner as in Example 1 except that 3 parts by weight of 2-benzyl-2-dimethylamino-1-(4-morpholinophenyl)-butanone-1 was used as a photoreactive polymerization initiator to be added to the pressure-sensitive adhesive in Example 1. The thickness of the pressure-sensitive adhesive layer was 20 μm and the absorption coefficient at a wavelength of 355 nm was 1006.8 cm⁻¹. The chip fry ratio was 78%.

### Comparative Example 2

A silicon wafer fitted with a pressure-sensitive adhesive sheet was subjected to laser processing in the same manner as in Example 1 except that 0.5 part by weight of 1-[4-(2-hydroxyethoxy)-phenyl]-2-hydroxy-2-methyl-1-propane-1-one (absorbance at a wavelength of 355 nm in a 0.01% by weight acetonitrile solution: 0.05) was used as a photoreactive polymerization initiator in the acrylic pressure-sensitive adhesive (1) in Example 1. The thickness of the pressure-sensitive adhesive layer was 20 μm and the absorption coefficient at a wavelength of 355 nm was 15.4 cm⁻¹. The chip fry ratio was 19%.

As is apparent from the above Examples and Comparative Examples, when the absorption coefficient of the pressure-sensitive adhesive layer at a wavelength of 355 nm falls within the range of 50 cm⁻¹ to 900 cm⁻¹ and the absorbance of the light-absorbing agent, which is contained in the pressure-sensitive adhesive layer, in a 0.01% by weight acetonitrile solution at a wavelength of 355 nm falls within the range of 0.01 to 1.20, ablation processing by ultraviolet light absorption proceeds from the upper layer part to the lower layer part of the pressure-sensitive adhesive layer in sequence even after the laser light cut the workpiece and reaches the pressure-sensitive adhesive layer. Therefore, explosion of the pressure-sensitive adhesive layer and the base and processing of the pressure-sensitive adhesive layer in a transverse direction hardly occur and thus chip fry at laser dicing can be prevented. As a result, improvement in throughput by increasing laser power can be achieved. Moreover, since the laser-processed articles are not dropped out after processing, handling is easy. Furthermore, since low adhesiveness is realized by ultraviolet curing, peeling after processing is also easy.

While the present invention has been described in detail and with reference to specific embodiments thereof, it will be apparent to one skilled in the art that various changes and modifications can be made therein without departing from the scope thereof.

This application is based on Japanese patent application No. 2008-255896 filed on Oct. 1, 2008, the entire contents thereof being hereby incorporated by reference.

Further, all references cited herein are incorporated in their entireties.

What is claimed is:

1. A pressure-sensitive adhesive sheet for laser processing, which comprises a base and a pressure-sensitive adhesive layer provided on one surface of the base,
said pressure-sensitive adhesive layer having an absorption coefficient at a wavelength of 355 nm of from 50 cm⁻¹ to 900 cm⁻¹,
said pressure-sensitive adhesive layer containing a light-absorbing agent in which an absorbance of the light-absorbing agent in a 0.01% by weight acetonitrile solution at a wavelength of 355 nm is from 0.01 to 1.20, and
wherein the pressure-sensitive adhesive sheet is to be used at the time when a workpiece is laser-processed by a laser light having a wavelength of an ultraviolet region or a laser light enabling light absorption via multiphoton absorption process.

2. The pressure-sensitive adhesive sheet according to claim 1, wherein the light-absorbing agent is a photoreactive polymerization initiator.

3. The pressure-sensitive adhesive sheet according to claim 2, wherein the photoreactive polymerization initiator is at least one member selected from the group consisting of an alkylphenone-based compound, an α-alkylphenone-based compound, and an acylphosphine oxide-based compound.

4. The pressure-sensitive adhesive sheet according to claim 1, wherein the pressure-sensitive adhesive layer comprises a pressure-sensitive adhesive containing an acrylic polymer.

5. The pressure-sensitive adhesive sheet according to claim 1, wherein the pressure-sensitive adhesive layer comprises an ultraviolet ray-curable pressure-sensitive adhesive.

6. The pressure-sensitive adhesive sheet according to claim 1, wherein the pressure-sensitive adhesive layer comprises a pressure-sensitive adhesive containing an acrylic polymer having a carbon-carbon double bond in a side chain thereof.

7. The pressure-sensitive adhesive sheet according to claim 1, wherein the base has an absorption coefficient at a wavelength of 355 nm of 10 cm⁻¹ or less.

8. The pressure-sensitive adhesive sheet according to claim 1, wherein the base has a layer composed of polyethylene or polypropylene.

9. The pressure-sensitive adhesive sheet according to claim 1, wherein the base has at least one layer composed of a copolymer containing ethylene.

10. The pressure-sensitive adhesive sheet according to claim 1, wherein the workpiece is a semiconductor element.

11. A method for laser processing, which comprises:
attaching the pressure-sensitive adhesive sheet according to claim 1 to a workpiece, and
subsequently irradiating the workpiece with a laser light having a wavelength of a ultraviolet region or a laser light enabling light absorption via multiphoton absorption process from a surface opposite to the surface to which the pressure-sensitive adhesive sheet has been attached, thereby processing the workpiece by ablation.

12. The method for laser processing according to claim 11, wherein the workpiece is a semiconductor element, and the semiconductor element is separated into pieces by irradiation with the laser light to form semiconductor chips.
